(19) United States
(12) Patent Application Publication
(10) Pub. No.: US 2005/0012784 A1
(43) Pub. Date: Jan. 20, 2005

(54) Liquid-jet head and liquid-jet apparatus

(75) Inventor: Maki Ito, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/632,113

(22) Filed: Aug. 1, 2003

(30) Foreign Application Priority Data
Aug. 1, 2002 (JP) 2002-225335

(51) Int. Cl. B41J 2/045

(52) U.S. Cl. 347/68

(57) ABSTRACT

Provided are a liquid jet head and a liquid jet apparatus which are capable of reducing fluctuation of a displacement amount of a vibration plate by driving of piezoelectric elements. A liquid jet head comprising: a passage-forming substrate on which pressure generating chambers communicating with nozzle orifices are defined, and a piezoelectric element composed of a lower electrode, a piezoelectric layer and an upper electrode, which are provided on the passage-forming substrate while interposing a via a vibration plate therebetween, wherein, both ends of the piezoelectric layer in its width direction at a pressure generating chamber side are positioned in an opening region of the pressure generating chamber, and a relationship between a width x of the piezoelectric layer at the pressure generating chamber side and a width y of the pressure generating chamber at a vibration plate side satisfies 0.75≦x/y≦1. Thus, the fluctuation of the displacement amount of the vibration plate by the driving of the piezoelectric element can be reduced.

### BACKGROUND OF THE INVENTION

1. Field of the Invention

The present invention relates to a liquid-jet head and a liquid-jet apparatus, in which part of pressure generating chambers which communicate with nozzle orifices for ejecting liquid is formed of a vibration plate, and piezoelectric elements are formed on a surface of this vibration plate, and the liquid is ejected by displacement of the piezoelectric elements. Particularly, the present invention relates to an ink-jet recording head which ejects ink as the liquid and an ink-jet recording apparatus.

2. Description of the Related Art

In an ink-jet recording head, part of pressure generating chambers communicating with nozzle orifices for ejecting ink droplets is formed of a vibration plate, and this vibration plate is deformed by piezoelectric elements, and ink in the pressure generating chambers is pressurized, and thus the ink droplets are ejected from the nozzle orifices. There are two types of ink-jet recording heads which have been put to practical use. One uses a piezoelectric actuator of a longitudinal vibration mode which extends and contracts in an axial direction of the piezoelectric element, and the other uses a piezoelectric actuator of a flexure vibration mode.

The former can change a volume of the pressure generating chamber by allowing an end face of the piezoelectric element to abut on the vibration plate and can be manufactured as a head suitable for high-density printing. However, a difficult process of cutting the piezoelectric element into a comb-teeth shape while allowing the piezoelectric element to coincide with an array pitch of the nozzle orifices and work of aligning the cut piezoelectric elements with the pressure generating chambers and fixing the piezoelectric elements thereto are required. Accordingly, there arises a problem that a manufacturing process thereof is difficult.

On the other hand, in the latter, the piezoelectric elements can be fabricated on the vibration plate by a relatively simple process of attaching a green sheet of a piezoelectric material to the vibration plate in accordance with shapes of the pressure generating chambers and performing baking thereof. However, because of the use of flexure vibration, a certain area is required. Accordingly, there arises a problem that high-density arrangement is difficult.

Meanwhile, in order to resolve the inconvenience of the latter recording head, there is proposed one in which a uniform piezoelectric material layer is formed across an entire surface of the vibration plate by use of a deposition technology, and this piezoelectric material layer is cut into shapes corresponding to the pressure generating chambers by use of a lithography method, and the piezoelectric elements are formed so as to be independent for each of the pressure generating chambers, as disclosed in Japanese Patent Laid-Open Publication No. Hei 5 (1993)-286131.

According to the above-described proposal, work of attaching the piezoelectric elements to the vibration plate is not required and the piezoelectric elements can be fabricated with high density by use of an accurate and simple method, the lithography method. In addition, there is an advantage that a thickness of the piezoelectric element can be reduced and thus high-speed drive becomes possible.

Here, the piezoelectric element is formed, for example, by sequentially layering a lower electrode, a piezoelectric layer and an upper electrode on one side of a single crystal silicon substrate. Such a piezoelectric layer is made of, for example, lead-zirconate-titanate (Pb (Zr, Ti) O₃; PZT) and the like.

In the above-described ink-jet recording head, for example, a driving voltage is applied from external wiring and the like to the lower and upper electrodes which sandwich the piezoelectric layer and the piezoelectric layer generates a predetermined a drive electric field to perform flexible deformation of the piezoelectric element, the vibration plate and the like. Thus, an internal pressure of the pressure generating chamber is substantially increased and the ink droplets are ejected from the nozzle orifice.

However, in the conventional ink-jet recording head, the piezoelectric element is driven repeatedly and thus there is a problem that a displacement amount of the vibration plate is significantly lowered compared to a displacement amount thereof in its initial state.

Specifically, residual polarization of the piezoelectric layer is increased by the repeated driving of the piezoelectric element and thus residual strain of the piezoelectric layer is increased. Consequently, even when the piezoelectric element is not driven, the vibration plate is in a state of being subjected to flexible deformation, that is, a state of being deformed into a convex shape toward the pressure generating chamber. Accordingly, there arises a problem that the displacement amount of the vibration plate by the driving of the piezoelectric element is lowered by about as much as 15% from that of the initial state.

Note that, as a matter of course, such problems as described above similarly arise not only in the ink-jet recording head but also in other liquid-jet heads. cl SUMMARY OF THE INVENTION

In consideration for the circumstances as described above, the object of the present invention is to provide a liquid-jet head and a liquid-jet apparatus, which can reduce fluctuation of a displacement amount of the vibration plate by driving of the piezoelectric element.

A first aspect of the present invention for achieving the foregoing object is a liquid-jet head comprising: a passage-forming substrate on which pressure generating chambers communicating with nozzle orifices are defined; and a piezoelectric element composed of a lower electrode, a piezoelectric layer and an upper electrode, which are provided on the passage-forming substrate while interposing a vibration plate therebetween, wherein, both ends of the piezoelectric layer in its width direction at a pressure generating chamber side are positioned in a region facing the pressure generating chamber, and a relationship between a width x of the piezoelectric layer at the pressure generating chamber side and a width y of the pressure generating chamber at the vibration plate side satisfies 0.75≦x/y≦1.

In the first aspect, by adjusting the relationship between the width x of the piezoelectric layer and the width y of the pressure generating chamber, that is, by satisfying the condition of 0.75≦x/y≦1, an increase in an initial displacement amount of the vibration plate due to residual strain generated in the piezoelectric layer by repeated driving of the piezoelectric element can be suppressed. Thus, the fluctuation of the displacement amount of the vibration plate by the driving of the piezoelectric element can be reduced.

A second aspect of the present invention is the liquid-jet head according to the first aspect, characterized in that the width x of the piezoelectric layer at the pressure generating chamber side and the width y of the pressure generating chamber at the vibration plate side are equal.

In the second aspect, the increase in the initial displacement amount of the vibration plate due to the residual strain generated in the piezoelectric layer can be more effectively suppressed.

A third aspect of the present invention is the liquid-jet head according to one of the first and second aspects, characterized in that the width y of the pressure generating chamber at the vibration plate side is defined by outer peripheries at both sides of a space portion in its width direction, the space portion being provided at a periphery of an opening of the pressure generating chamber at the vibration plate side.

In the third aspect, a region corresponding to the space portion of the vibration plate becomes a vibration region and, by defining the width y of the pressure generating chamber by the outer peripheries at both the sides of the space portion in its width direction, the increase in the initial displacement amount of the vibration plate due to the residual strain generated in the piezoelectric layer can be effectively suppressed.

A fourth aspect of the present invention is the liquid-jet head according to any one of the first to third aspects, characterized in that the pressure generating chambers are formed in a single crystal silicon substrate by anisotropic etching and each layer of the piezoelectric element is formed by deposition and a lithography method.

In the fourth aspect, liquid-jet heads having high-density nozzle orifices can be manufactured in large quantities and relatively easily.

A fifth aspect of the present invention is a liquid-jet apparatus including the liquid-jet head according to any one of the first to fourth aspects.

In the fifth aspect, it is possible to provide the liquid-jet apparatus in which liquid-jet properties are improved by reducing the fluctuation of the displacement amount of the vibration plate.

### BRIEF DESCRIPTION OF THE DRAWINGS

FIG. 1 is an exploded perspective view of an ink-jet recording head according to embodiment 1 of the present invention.

FIG. 2A is a plan view of the ink-jet recording head according to embodiment 1 of the present invention, and FIGS. 2B and 2C are sectional views taken along the lines A-A′ and B-B′ in FIG. 2A.

FIG. 3 is an enlarged cross-sectional view of a main part of FIG. 2C according to embodiment 1 of the present invention.

FIG. 4 is a line chart showing a relationship between pulse number and a displacement amount in an example and comparative examples according to embodiment 1 of the present invention.

FIG. 5 is an enlarged cross-sectional view of a main part of an ink-jet recording head according to another embodiment of the present invention.

FIG. 6 is a schematic perspective view of an ink-jet recording apparatus according to an embodiment of the present invention.

### DESCRIPTION OF THE PREFERRED EMBODIMENTS

The present invention will now be described in detail below based on embodiments.

(Embodiment 1)

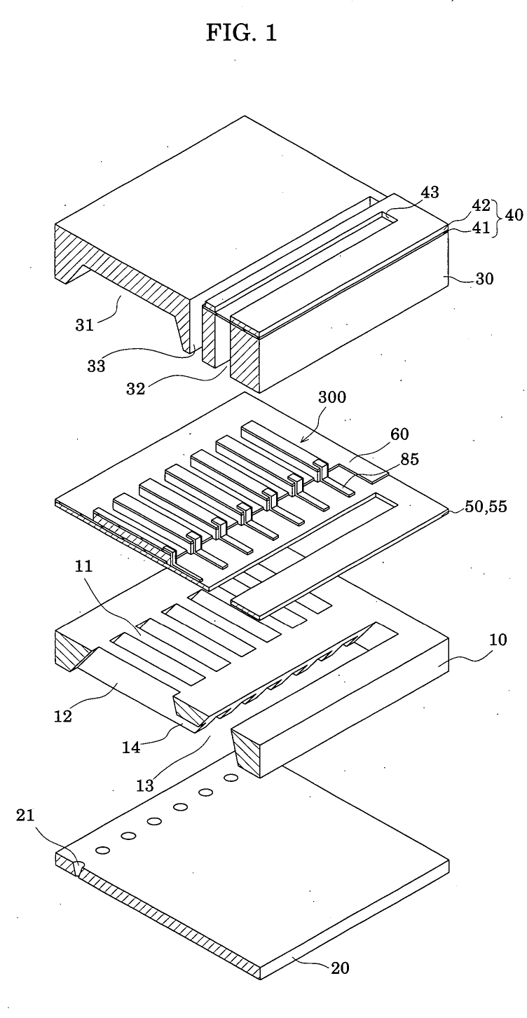

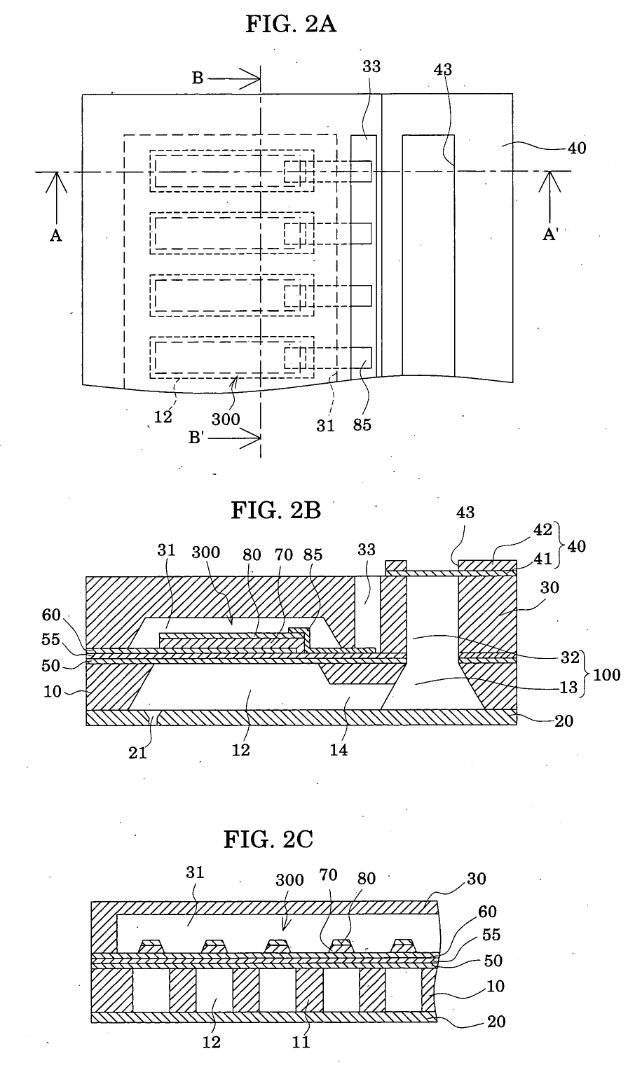

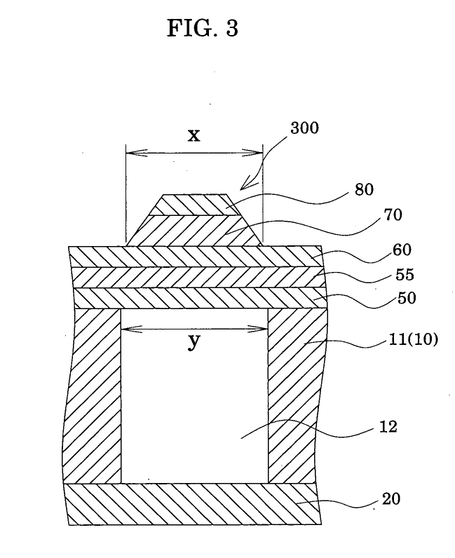

FIG. 1 is an exploded perspective view schematically showing an ink-jet recording head according to embodiment 1 of the present invention. FIG. 2A is a plan view of FIG. 1, and FIGS. 2B and 2C are sectional views taken along the lines A-A′ and B-B′ in FIG. 2A. FIG. 3 is an enlarged cross-sectional view of a main part of FIG. 2C.

As shown in FIG. 1, a passage-forming substrate 10 is made of a single crystal silicon substrate of plane orientation (110) in this embodiment and, on one surface thereof, an elastic film 50 with a thickness of 1 to 2 μm which is made of silicon dioxide (SiO₂) previously formed by thermal oxidation, is formed.

In this passage-forming substrate 10, pressure generating chambers 12 partitioned by a plurality of compartment walls 11 are arranged in parallel in a width direction of the substrate by performing anisotropic etching of the single crystal silicon substrate from one side thereof. Moreover, on the outside in longitudinal directions of the pressure generating chambers 12, a communicating portion 13 is formed, which is to communicate with a reservoir portion 32 of a sealing plate 30 to be described later. The communicating portion 13 communicates with the end portions on one side in the longitudinal directions of the respective pressure generating chambers 12 via respective ink supply paths 14.

Here, anisotropic etching is performed by utilizing a difference in an etching rate of the single crystal silicon substrate. For example, in this embodiment, when the single crystal silicon substrate is dipped in an alkaline solution such as KOH, the substrate is gradually eroded and there appear a first (111) plane perpendicular to the (110) plane and a second (111) plane making about a 70-degree angle with this first (111) plane and about a 35-degree angle with the foregoing (110) plane. Thus, the anisotropic etching is performed by utilizing a characteristic that the etching rate of the (111) planes is about 1/180 in comparison with the (110) plane. By use of the anisotropic etching, high-precision processing can be performed on the basis of depth processing of a parallelogram shape, which is formed by two of the first (111) planes and two of the oblique second (111) planes. Thus, the pressure generating chambers 12 can be arranged with high density.

In this embodiment, long sides of each pressure generating chamber 12 are formed of the first (111) planes and short sides thereof are formed of the second (111) planes. This pressure generating chamber 12 is formed by performing etching up to the elastic film 50 while nearly penetrating the passage-forming substrate 10. Here, extremely small part of the elastic film 50 is eroded by the alkaline solution used for the etching of the single crystal silicon substrate. Moreover, each of the ink supply paths 14 communicating with the end portions on one side of the respective pressure generating chambers 12 is formed to be shallower than the pressure generating chamber 12, and thus passage resistance of ink flowing into the pressure generating chamber 12 is maintained constant. Specifically, the ink supply path 14 is formed by performing half-etching of the single crystal silicon substrate in its thickness direction. Note that the half-etching is performed by controlling an etching time.

A thickness of the passage-forming substrate 10, in which such pressure generating chambers 12 and the like are formed, is preferably selected to be optimum in accordance with a density of arrangement of the pressure generating chambers 12. For example, in the case of disposing about 180 of the pressure generating chambers 12 per inch (180 dpi), the thickness of the passage-forming substrate 10 is preferably set to about 180 to 280 μm, more preferably set to about 220 μm. Moreover, in the case of disposing the pressure generating chambers 12 with relatively high density of, e.g., about 360 dpi, the thickness of the passage-forming substrate 10 is preferably set to 100 μm or less. This is because an array density of the pressure generating chambers 12 can be increased while maintaining rigidity of the compartment walls 11 between the adjacent pressure generating chambers 12.

Note that, to an open face side of the passage-forming substrate 10, a nozzle plate 20 having nozzle orifices 21 drilled therein is fixed by use of an adhesive agent, a thermowelding film or the like. The nozzle orifices 21 communicate with the pressure generating chambers 12 at sides opposite to the ink supply paths 14.

Meanwhile, on the elastic film 50 at a side opposite to the open face of the passage-forming substrate 10, an insulation layer 55 made of zirconium dioxide (ZrO₂) is formed. On this insulation layer 55, a lower electrode film 60 having a thickness of, e.g., about 0.2 μm a piezoelectric layer 70 having a thickness of, e.g., about 1 μm and an upper electrode film 80 having a thickness of, e.g., about 0.1 μm are formed in layers to constitute a piezoelectric element 300. Note that, in this embodiment, the lower electrode 60 is formed by sequentially layering a titanium layer, an iridium layer, a platinum layer, an iridium layer and a titanium layer on the insulation layer 55. Moreover, the piezoelectric layer 70 is made of lead-zirconate-titanate (Pb (Zr, Ti) O₃; PZT)

Here, the piezoelectric element 300 means a part including the lower electrode film 60, the piezoelectric layer 70 and the upper electrode film 80. In general, the piezoelectric element 300 is formed by using any one of the electrodes thereof as a common electrode and patterning the other electrode and the piezoelectric layer 70 for each of the pressure generating chambers 12. Moreover, here, a part which includes any one of the electrodes that is patterned and the piezoelectric layer 70 and in which piezoelectric strain occurs due to voltage application to both the electrodes is called a piezoelectric active portion. In this embodiment, the lower electrode film 60 is used as the common electrode of the piezoelectric element 300 and the upper electrode film 80 is used as an individual electrode thereof. However, even if this order is reversed on account of a drive circuit and wiring, there is no trouble caused thereby.

In any case, the piezoelectric active portion is formed for each of the pressure generating chambers 12. Moreover, here, the piezoelectric element 300 and the vibration plate displaced by driving of the piezoelectric element 300 are collectively called a piezoelectric actuator. Note that, in this embodiment, the elastic film 50, the insulation layer 55 and the lower electrode film 60 function as the vibration plate.

In this embodiment, as shown in FIG. 3, widths of the piezoelectric layer 70 and the upper electrode film 80 of the piezoelectric element 300 as described above become gradually wider from an upper electrode film 80 side toward the lower electrode film 70 and a cross section of the piezoelectric layer 70 and the upper electrode film 80 has an approximately trapezoidal shape. Moreover, angles of inclination of both sides of the piezoelectric layer 80 with respect to a bottom of the piezoelectric layer 80 at a pressure generating chamber 12 side, that is, a surface thereof at an insulation layer 55 side are 30° to 60°, for example. In this embodiment, the angles are about 45°.

Moreover, the piezoelectric layer 70 of the piezoelectric element 300 as described above is provided in a region facing the above-described pressure generating chamber 12. Specifically, both ends of the bottom of the piezoelectric layer 70 in its width direction at the pressure generating chamber 12 side are positioned within an opening region of the pressure generating chamber 12.

Here, a relationship between a width x of the bottom of the piezoelectric layer 70 at the pressure generating chamber 12 side and a width y of the pressure generating chamber 12 at an elastic film 50 side satisfies 0.75≦x/y≦1, and particularly, the width x of the piezoelectric layer 70 is preferably equal to the width y of the pressure generating chamber 12. For example, in this embodiment, the relationship between the width x of the piezoelectric layer 70 and the width y of the pressure generating chamber 12 is set to satisfy x/y=0.8. Note that the width y of the pressure generating chamber 12 means the width thereof at the elastic film 50 side, that is, an interval between the side walls 11. This is because the width of the pressure generating chamber 12 at the elastic film 50 side substantially defines a region where the above-described vibration plate is deformed.

As described above, in this embodiment, the relationship between the width x of the piezoelectric layer 70 at the pressure generating chamber 12 side and the width y of the pressure generating chamber 12 at the vibration plate side is adjusted, that is, set to 0.75≦x/y≦1. Thus, rigidity of the vibration plate is substantially improved and an increase in an initial displacement amount of the vibration plate due to residual strain generated in the piezoelectric layer 70 by repeated driving of the piezoelectric element 300 is suppressed. Accordingly, fluctuation of the displacement amount of the vibration plate by the driving of the piezoelectric element 300 can be reduced and stable ink ejecting properties can be obtained over a long period of time. When the width x of the piezoelectric layer 70 and the width y of the pressure generating chamber 12 are set to be equal in particular, the fluctuation of the displacement amount of the vibration plate can be further reduced.

Note that the fluctuation of the displacement amount of the vibration plate can be also reduced by setting the relationship between the width x of the piezoelectric layer 70 and the width y of the pressure generating chamber 12 to satisfy x/y>1. However, the above setting is not preferable because the displacement amount itself of the vibration plate by the driving of the piezoelectric element 300 becomes too small.

Moreover, to the upper electrode film 80 of each piezoelectric element 300 as described above, a lead electrode 85 made of, e.g., gold (Au) or the like is connected. This lead electrode 85 is led out from the vicinity of an end in a longitudinal direction of each piezoelectric element 300 and is extended to the elastic film 50 in a region corresponding to the ink supply path 14.

To the passage-forming substrate 10 at the piezoelectric element 300 side, joined is the sealing plate 30 having a piezoelectric element holding portion 31 which can seal a space in a state of securing the space without interfering with movement of the piezoelectric elements 300. The piezoelectric elements 300 are sealed in this piezoelectric element holding portion 31.

Moreover, in the sealing plate 30, a reservoir portion 32 constituting at least a part of a reservoir 100 to be a common ink chamber of each pressure generating chamber 12 is provided. This reservoir portion 32 is allowed to communicate with the communicating portion 13 of the passage-forming substrate 10 as described above, thus constituting the reservoir 100 to be the common ink chamber of each pressure generating chamber 12.

Furthermore, between the piezoelectric element holding portion 31 and reservoir portion 32 of the sealing plate 30, that is, in a region corresponding to the ink supply paths 14, a connection hole 33 penetrating the sealing plate 30 in its thickness direction is provided. Moreover, on a surface of the sealing plate 30 at a side opposite to the piezoelectric element holding portion 31 side, unillustrated external wiring is provided. The lead electrodes 85 led out from the respective piezoelectric elements 300 are extended to this connection hole 33 and are connected to the external wiring by wire bonding or the like.

Moreover, onto the sealing plate 30, a compliance plate 40 including a sealing film 41 and a fixed plate 42 is joined. Here, the sealing film 41 is made of a material having flexibility and low rigidity (for example, a polyphenylene sulfide (PPS) film with a thickness of 6 μm). The fixed plate 42 is formed of a hard material such as metal (for example, stainless-steel (SUS) with a thickness of 30 μm or the like). An opening portion 43, which is obtained by entirely removing the fixed plate 42 in its thickness direction, is formed in a region corresponding to the reservoir 100 of this fixed plate 42. Thus, one side of the reservoir 100 is sealed only by the sealing film 41 having flexibility.

Note that, in such an ink-jet recording head as described above, ink is supplied from unillustrated external ink supply means and the ink fills an inside of the ink-jet recording head from the reservoir 100 to the nozzle orifices 21. Thereafter, in accordance with a record signal from an unillustrated drive circuit, voltages are applied between the corresponding lower and upper electrode films 60 and 80 of the respective pressure generating chambers 12 via the external wiring. The elastic film 50, the insulation layer 55, the lower electrode film 60 and the piezoelectric layer 70 are thereby subjected to flexible deformation. Thus, pressures in the respective pressure generating chambers are increased and the ink droplets are ejected from the nozzle orifices 21.

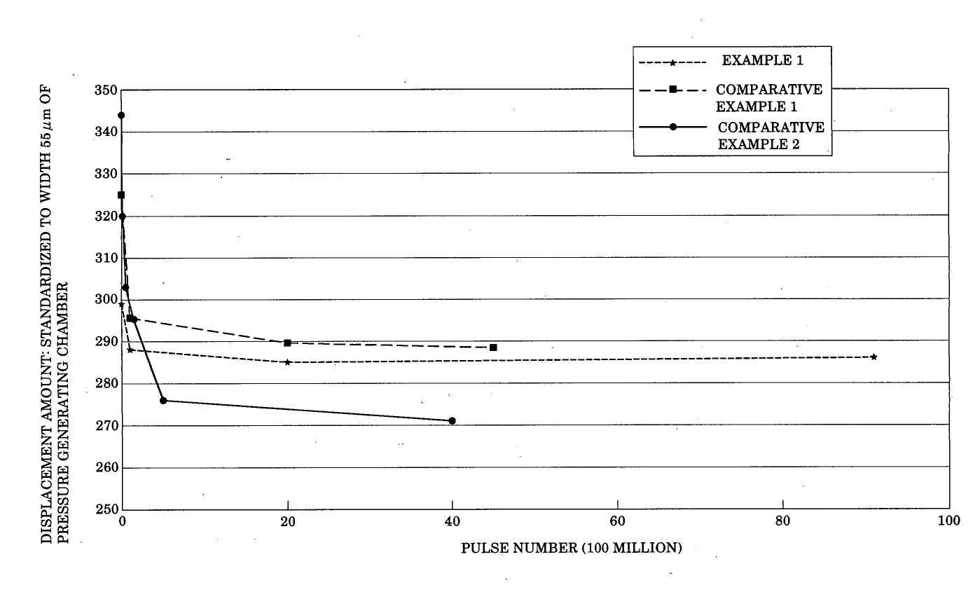

Here, ink-jet recording heads are prepared in accordance with example 1 and comparative examples 1 and 2 described below, in which the width y of the pressure generating chamber is standardized to be 55 μm and the width x of the piezoelectric layer is changed. With these ink-jet recording heads, a relationship between the pulse number applied to the piezoelectric element and a displacement amount of the vibration plate is examined. A result of the examination is shown in FIG. 4. Incidentally, FIG. 4 is a line chart showing the relationship between the pulse number and the displacement amount.

### (EXAMPLE 1)

The ink-jet recording head of example 1 was prepared by setting the relationship between the width x of the piezoelectric layer and the width y of the pressure generating chamber to satisfy x/y=0.80.

### (Comparative Example 1)

The ink-jet recording head of comparative example 1 was prepared by setting the relationship between the width x of the piezoelectric layer and the width y of the pressure generating chamber to satisfy x/y=0.70.

### (Comparative Example 2)

The ink-jet recording head of comparative example 2 was prepared by setting the relationship between the width x of the piezoelectric layer and the width y of the pressure generating chamber to satisfy x/y=0.67.

As shown in FIG. 4, the displacement amount of the ink-jet recording head of comparative example 1 was lowered by about 11% from an initial value (0 pulse) and the displacement amount of the ink-jet recording head of comparative example 2 was lowered by about 21% from the initial value. On the other hand, lowering of the displacement amount of the ink-jet recording head of example 1 was able to be suppressed to about 5% from the initial value.

As is apparent from the result as described above, when the relationship between the width x of the piezoelectric layer and the width y of the pressure generating chamber satisfies 0.75≦x/y≦1, the fluctuation of the displacement amount from the initial value can be dramatically reduced.

(Other Embodiments)

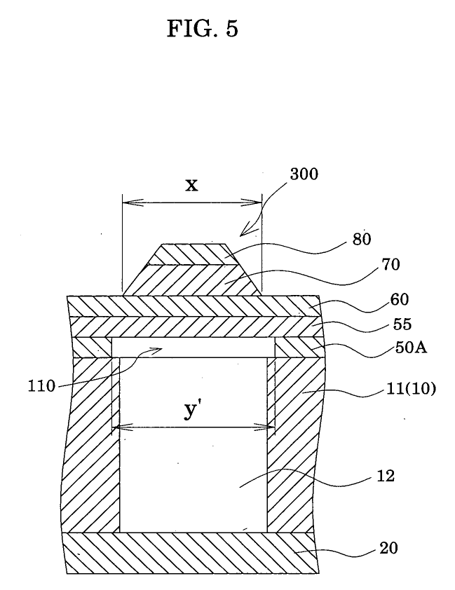

Although an embodiment has been described above, the configuration of the present invention is not limited to the one described above. Note that FIG. 5 is an enlarged cross-sectional view of a main part of an ink-jet recording head according to another embodiment of the present invention.

For example, in the above-described embodiment 1, the width y of the pressure generating chamber 12 is defined by the interval between the side walls 11 on both sides of the pressure generating chamber 12 at the elastic film 50 side. However, the width y is not limited to this. As shown in FIG. 5, when a space portion 110 is provided in the pressure generating chamber 12 at an elastic film 50A side, a width y′ of the pressure generating chamber 12 is defined by outer edges at both sides of the space 110 in its width direction. With such a configuration, a similar effect to the above-described embodiment 1 can be also obtained.

Moreover, a thin-film ink-jet recording head manufactured by applying the deposition and lithography process thereto has been taken as an example. However, it is needless to say that the present invention is not limited to this. For example, the present invention can also be adopted in a thick-film ink-jet recording head manufactured by use of a method of attaching a green sheet.

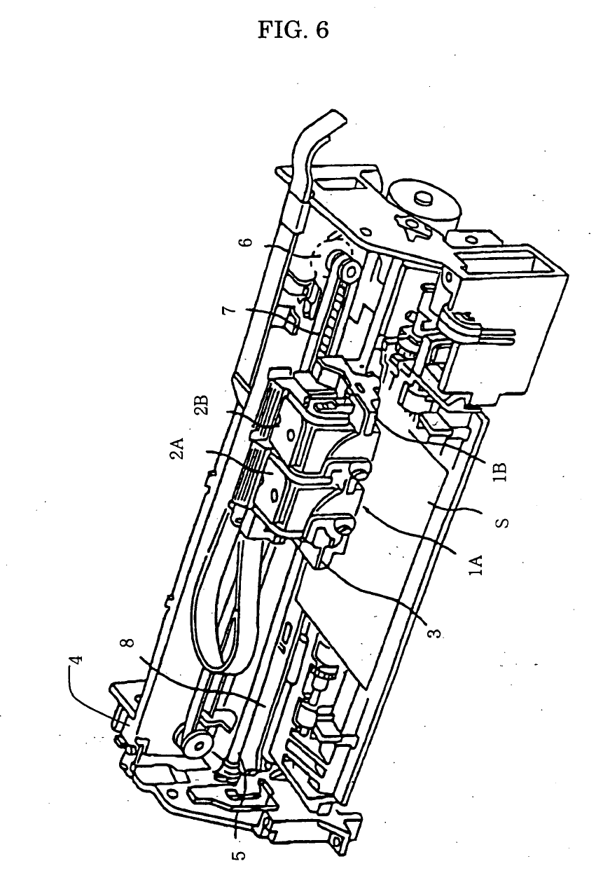

Moreover, such an ink-jet recording head of the present invention constitutes a part of a recording head unit including an ink passage which communicates with an ink cartridge and the like and is built in an ink-jet recording apparatus. FIG. 6 is a schematic view showing an example of the ink-jet recording apparatus.

As shown in FIG. 6, in recording head units 1A and 1B having the ink-jet recording heads, cartridges 2A and 2B included in ink supply means are detachably provided. A carriage 3 having these recording head units 1A and 1B mounted thereon is provided on a carriage shaft 5 attached to an apparatus main body 4 to be movable in an axial direction of the carriage shaft 5. These recording head units 1A and 1B are, for example, those which eject a black ink composition and a color ink composition, respectively.

A driving force of a drive motor 6 is transmitted to the carriage 3 via an unillustrated plurality of gears and a timing belt 7. Thus, the carriage 3 having the recording head units 1A and 1B mounted thereon is moved along the carriage shaft 5. Meanwhile, a platen 8 is provided along the carriage shaft 5 in the apparatus main body 4 and a recording sheet S, which is a recording medium such as paper fed by an unillustrated feed roller or the like, is carried on the platen 8.

Here, in the above-described embodiments, an ink-jet recording head has been described as an example of the liquid-jet head of the present invention. However, the basic configuration of the liquid-jet head is not limited to the one described above. The present invention is aimed widely at general liquid-jet heads and can be applied to other liquid-jet heads including, for example: various kinds of recording heads used in an image recording apparatus such as a printer; a color material jet head used for manufacturing color filters of a liquid crystal display and the like; an electrode material jet head used for forming electrodes of an organic EL display, a field emission display (FED) and the like; a bio-organic matter jet head used for manufacturing biochips; and the like. It is needless to say that a liquid-jet apparatus having such a liquid-jet head mounted thereon is not particularly limited.

As described above, in the present invention, both ends of the piezoelectric layer in its width direction at the pressure generating chamber side are positioned within the region facing the pressure generating chamber, and the relationship between the width x of the piezoelectric layer at the pressure generating chamber side and the width y of the pressure generating chamber at the vibration plate side is set to satisfy 0.75≦x/y≦1. Thus, the fluctuation of the displacement amount of the vibration plate by the driving of the piezoelectric element can be reduced and stable liquid ejecting properties can be obtained over a long period of time.

1. A liquid-jet head comprising:
a passage-forming substrate on which pressure generating chambers communicating with nozzle orifices are defined, and a piezoelectric element composed of a lower electrode, a piezoelectric layer and an upper electrode, which are provided on the passage-forming substrate while interposing a vibration plate therebetween,
wherein, both ends of the piezoelectric layer in its width direction at a pressure generating chamber side are positioned in a region facing the pressure generating chamber, and a relationship between a width x of the piezoelectric layer at the pressure generating chamber side and a width y of the pressure generating chamber at the vibration plate side satisfies 0.75≦x/y≦1.

2. The liquid-jet head according to claim 1,
wherein the width x of the piezoelectric layer at the pressure generating chamber side and the width y of the pressure generating chamber at the vibration plate side are equal.

3. The liquid-jet head according to claim 1,
wherein the width y of the pressure generating chamber at the vibration plate side is defined by outer peripheries at both sides of a space portion in its width direction, the space being provided at a periphery of an opening of the pressure generating chamber at the vibration plate side.

4. The liquid-jet head according to claim 1,
wherein the pressure generating chambers are formed in a single crystal silicon substrate by anisotropic etching, and each layer of the piezoelectric element is formed by deposition and a lithography method.

5. A liquid-jet apparatus comprising:
the liquid-jet head according to any one of claims 1 to 4.
